(19) United States
(12) Patent Application Publication
(10) Pub. No.: US 2025/0363951 A1
(43) Pub. Date: Nov. 27, 2025

(54) DRIVER CIRCUIT, DISPLAY PANEL, AND DISPLAY DEVICE

(71) Applicant: Novatek Microelectronics Corp., Hsinchu (TW)

(72) Inventor: Po-Sheng Liao, Hsinchu City (TW)

(73) Assignee: Novatek Microelectronics Corp., Hsinchu (TW)

(21) Appl. No.: 19/216,727

(22) Filed: May 23, 2025

Related U.S. Application Data
(60) Provisional application No. 63/651,400, filed on May 24, 2024.

(51) Int. Cl. G09G 3/3258

(52) U.S. Cl. CPC G09G 3/3258; G09G 2300/0452; G09G 2330/023

(57) ABSTRACT

A driver circuit configured to drive a display panel is provided. The display panel includes a plurality of data lines and a plurality of subpixels. The driver circuit includes a plurality of first driver units and second driver units. The first driver units are supplied with a first operating voltage range and configured to drive blue subpixels. The second driver units are supplied with a second operating voltage range and configured to drive red subpixels. The first operating voltage range is larger than the second operating voltage range.

### CROSS-REFERENCE TO RELATED APPLICATION

This application claims the priority benefit of U.S. provisional application Ser. No. 63/651,400, filed on May 24, 2024. The entirety of the above-mentioned patent application is hereby incorporated by reference herein and made a part of this specification.

### BACKGROUND

### Technical Field

The invention relates to an electrical circuit, an electrical panel, and an electrical device, more specifically, to a driver circuit, a display panel, and a display device.

### Description of Related Art

Each pixel of a conventional OLED display panel shares the same power sources. However, different color pixels of the OLED display panel have different threshold voltages (Vth) and driving currents. The same driving voltage power shared by each pixel of the OLED display panel may cause voltage waste at different levels.

On the other hand, in the display driver ICs of the conventional OLED display device, all the source operational amplifiers (SOPs) have the same operating voltage. The SOPs output data voltages to charge data lines of the OLED display panel. Since different color pixels of the OLED display panel require data voltages in different ranges, power consumption is wasted at different levels.

### SUMMARY

The invention is directed to a driver circuit, a display panel, and a display device, capable of avoiding a waste of power consumption caused by all the SOPs sharing the same operating voltage. Accordingly, a power saving effect is achieved.

An embodiment of the invention provides a driver circuit, configured to drive a display panel. The display panel includes a plurality of data lines and a plurality of subpixels. The driver circuit includes a plurality of first driver units and second driver units. The first driver units are supplied with a first operating voltage range and configured to drive blue subpixels. The second driver units are supplied with a second operating voltage range and configured to drive red subpixels. The first operating voltage range is larger than the second operating voltage range.

An embodiment of the invention provides a display panel, including a plurality of pixel units. Each of the pixel units includes at least two of a blue subpixel, a red subpixel, and a green subpixel. The blue subpixel is coupled between a first voltage and a second voltage. The first voltage is larger than the second voltage. The red subpixel is coupled between a third voltage and the second voltage. The third voltage is larger than the second voltage. The green subpixel is coupled between a fourth voltage and the second voltage. The fourth voltage is larger than the second voltage. At least two voltages of the first voltage, the third voltage, and the fourth voltage have different voltage values.

An embodiment of the invention provides a display device, including a display panel and a driver circuit. The display panel includes a plurality of data lines and a plurality of pixel units. Each of the pixel units includes at least two of a blue subpixel, a red subpixel, and a green subpixel. The driver circuit is configured to drive the display panel. The driver circuit includes a plurality of first driver units and second driver units. The first driver units are supplied with a first operating voltage range and configured to drive blue subpixels. The second driver units are supplied with a second operating voltage range and configured to drive red subpixels. The first operating voltage range is larger than the second operating voltage range.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram illustrating a display device according to an embodiment of the invention.

FIG. 2 is a block diagram illustrating the display device of FIG. 1 according to an embodiment of the invention.

FIG. 3 is a circuit diagram illustrating the display device of FIG. 1 according to an embodiment of the invention.

FIG. 4 is a circuit diagram illustrating the driver units of FIG. 3 according to an embodiment of the invention.

FIG. 5 is a schematic diagram illustrating pixel units of FIG. 3 according to an embodiment of the invention.

FIG. 6A and FIG. 6B are schematic diagrams respectively illustrating a display device operating in an odd line period and an even line period according to an embodiment of the invention.

FIG. 7A and FIG. 7B are schematic diagrams respectively illustrating a display device operating in the odd line period and the even line period according to another embodiment of the invention.

FIG. 8 is a schematic diagram illustrating a display device according to another embodiment of the invention.

FIG. 9 is a schematic diagram illustrating a display device according to another embodiment of the invention.

FIG. 10 is a schematic diagram illustrating a display device according to another embodiment of the invention.

FIG. 11 is a schematic diagram illustrating a display device according to another embodiment of the invention.

### DESCRIPTION OF THE EMBODIMENTS

Embodiments are provided below to describe the disclosure in detail, though the disclosure is not limited to the provided embodiments, and the provided embodiments could be suitably combined. The term “coupling/coupled” or “connecting/connected” used in this specification (including claims) of the application may refer to any direct or indirect connection means. For example, “a first device is coupled to a second device” should be interpreted as “the first device is directly connected to the second device” or “the first device is indirectly connected to the second device through other devices or connection means.” In addition, the term “signal” could refer to a current, a voltage, a charge, a temperature, data, electromagnetic wave or any one or multiple signals.

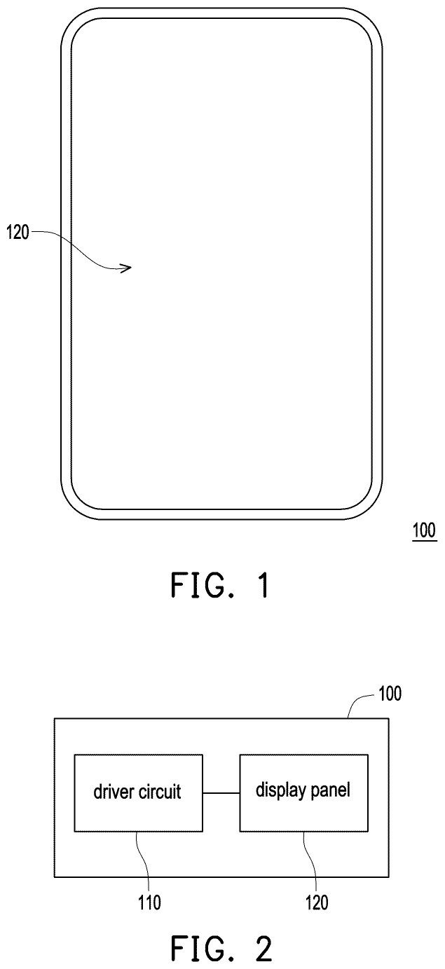

FIG. 1 is a schematic diagram illustrating a display device according to an embodiment of the invention. FIG. 2 is a block diagram illustrating the display device of FIG. 1 according to an embodiment of the invention. Referring to FIG. 1 and FIG. 2, the display device 100 includes a driver circuit 110 and a display panel 120. The driver circuit 110 is configurable to be coupled to the display panel 120. The display panel 120 may be a self-illuminated display panel, e.g. an organic light-emitting diode (OLED) display panel, but the invention is not limited thereto. The display panel 120 may be a subpixel rendering display panel or a true RGB display panel.

In an embodiment, the display device 100 may be an electronic device having a display function, a touch sensing function and/or a fingerprint sensing function. In an embodiment, the display device 100 may be, but not limited to, a smartphone, a non-smart phone, a wearable electronic device, a tablet computer, a personal digital assistant, a notebook and other portable electronic devices that could operate independently and have the display function, the touch sensing function and/or the fingerprint sensing function. In an embodiment, the electronic device 100 may be, but not limited to, a portable or un-portable electronic device in a vehicle intelligent system. In an embodiment, the display device 100 may be, but not limited to, intelligent home appliances such as, a television, a computer, a refrigerator, a washing machine, a telephone, an induction cooker, a table lamp and so on.

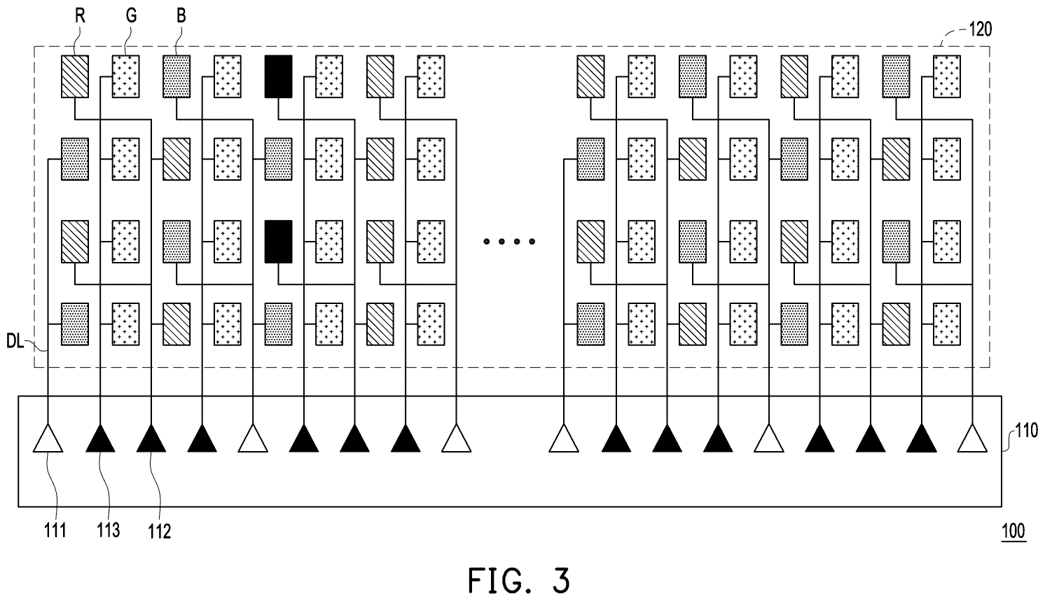

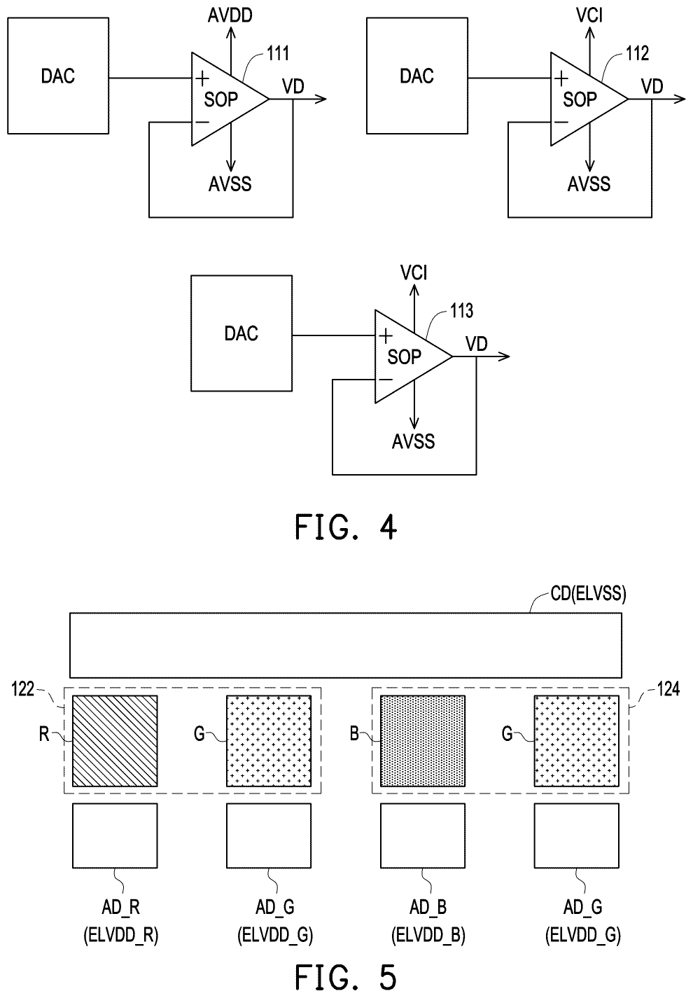

FIG. 3 is a circuit diagram illustrating the display device of FIG. 1 according to an embodiment of the invention. FIG. 4 is a circuit diagram illustrating the driver units of FIG. 3 according to an embodiment of the invention. Referring to FIG. 3 and FIG. 4, the driver circuit 110 includes a plurality of first driver units 111, a plurality of second driver units 112, and a plurality of third driver units 113. The display panel 120 includes a plurality of data lines DL and a plurality of subpixels R, G, B.

As shown in FIG. 3, the data lines of the display panel 120 are arranged in a zigzag wiring pattern. Each data line is only connected to the subpixel of the same color, and the data voltage VD outputted by each SOP (source operational amplifier) of the driver circuit 110 is configured to drive the subpixel of the same color.

To be specific, the first driver units 111, the second driver units 112, and the third driver units 113 are configured to drive blue subpixels B, red subpixels R, and green subpixels G, respectively. The operating voltages AVSS, VCI AVDD are operation powers coupled to respective SOPs of the driver units, wherein the operating voltage AVSS is lower than the operating voltage VCI, and the operating voltage VCI is lower than the operating voltage AVDD, i.e. AVSS<VCI<AVDD. The first driver units 111 driving blue subpixels are supplied with a first operating voltage range AVSS to AVDD, and the second driver units driving red subpixels 112 and the third driver units 113 driving green subpixels are supplied with a second operating voltage range AVSS to VCI. In another embodiment, the third driver units 113 driving blue subpixels may be supplied with the first operating voltage range AVSS to AVDD.

In the present embodiment, the minimum voltage AVSS of the first operating voltage range AVSS to AVDD is the same as that of the second operating voltage range AVSS to VCI, and the maximum voltage AVDD of the first operating voltage range VSS to AVDD is larger than the maximum voltage VCI of the second operating voltage range AVSS to VCI. However, the invention is not limited thereto. In another embodiment, the minimum voltage of the first operating voltage range may be lower than that of the second operating voltage range, and the maximum voltage of the first operating voltage range is the same as that of the second operating voltage range.

FIG. 5 is a schematic diagram illustrating pixel units of FIG. 3 according to an embodiment of the invention, wherein anodes and cathodes of subpixels are further shown in FIG. 5. Referring to FIG. 3 and FIG. 5, the display panel 120 includes a plurality of pixel units 122 and 124. For a subpixel rendering display panel, each of the pixel units includes at least two of the blue subpixel B, the red subpixel R, and the green subpixel G. In this case, the pixel unit 122 includes one red subpixel R and one green subpixel G, and the pixel unit 124 includes one blue subpixel B and one green subpixel G, but the invention is not limited thereto. In another embodiment, for a true RGB display panel, each of the pixel units may include one blue subpixel B, one red subpixel R, and one green subpixel G.

In FIG. 5, the blue subpixel B, the red subpixel R, and the green subpixel G have separate anodes AD_B, AD_R, AD_G and a common cathode CD. The anodes AD_B, AD_R, AD_G are coupled to a first voltage ELVDD_B, a third voltage ELVDD_R, and a fourth voltage ELVDD_G, respectively, and insulated from each other. The cathode CD is coupled to a second voltage ELVSS. The first voltage ELVDD_B, the third voltage ELVDD_R, and the fourth voltage ELVDD_G are larger than the second voltage ELVSS.

In the present embodiment, at least two voltages of the first voltage ELVDD_B, the third voltage ELVDD_R, and the fourth voltage ELVDD_G have different voltage values. For example, the first voltage ELVDD_B, the third voltage ELVDD_R, and the fourth voltage ELVDD_G are all set to different voltage values 4.6 V, 3.0 V and 3.2 V. The first voltage ELVDD_B is larger than the fourth voltage ELVDD_G, and the fourth voltage ELVDD_G is larger than the third voltage ELVDD_R, i.e. ELVDD_B>ELVDD_G>ELVDD_R. The voltage values are not intended to limit the invention.

In the embodiments of FIG. 3 to FIG. 5, corresponding to the display panel 120 with different subpixels having different ELVDD voltages, the SOPs of the driver units adopt different operating voltages (not limited to the AVDD, and the VCI) in order to avoid a waste of power consumption caused by all the SOPs sharing the same operating voltage. Accordingly, a power saving effect is achieved by the driver circuit 110.

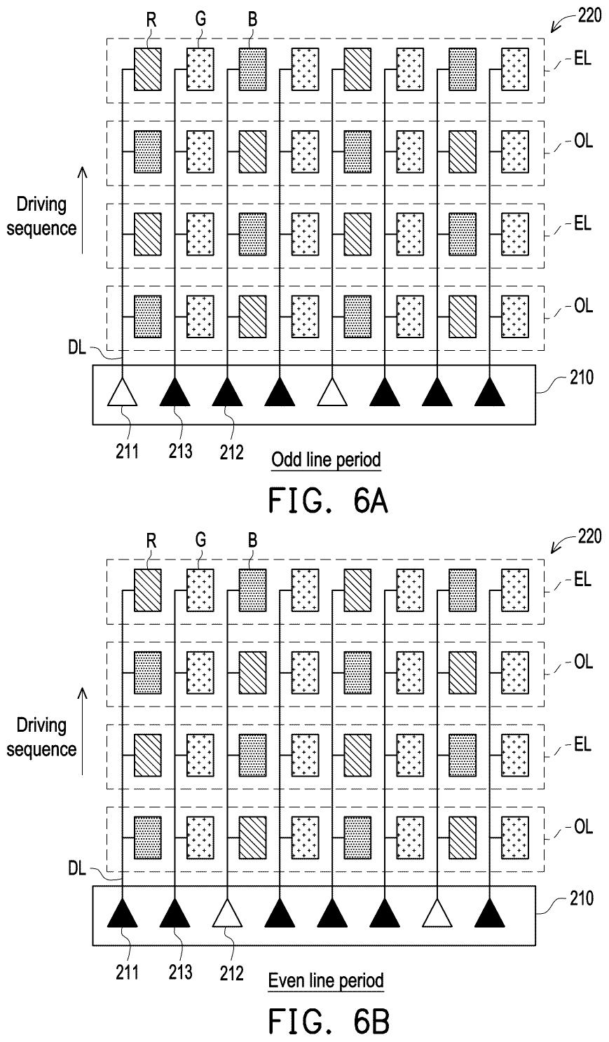

FIG. 6A and FIG. 6B are schematic diagrams respectively illustrating a display device operating in an odd line period (first line period) and an even line period (second line period) according to an embodiment of the invention, wherein the even line period is next to the odd line period. Referring to FIG. 6A and FIG. 6B, the data lines DL of the display panel 220 are arranged in a stripe wiring pattern. Some data lines DL are connected to the subpixels of two different colors (red and blue). The data lines DL are fixedly coupled to the corresponding driver units 211, 212 and 213, but the SOPs of the driver units 211, 212 and 213 may be switched to different operating voltages in different sequences to drive the subpixels of different colors.

For example, in the odd line period of FIG. 6A, the driver circuit 210 drives odd lines OL of the display panel 220, and in the even line period of FIG. 6B, the driver circuit 210 drives even lines EL of the display panel 220. In the present embodiment, the first driver unit 211 is supplied with the first operating voltage range AVSS to AVDD to drive the blue subpixel B in the odd line period, and is supplied with the second operating voltage range AVSS to VCI to drive the red subpixel R in the even line period. On the other hand, the second driver unit 212 is supplied with the second operating voltage range AVSS to VCI to drive the red subpixel R in the odd line period, and is supplied with the first operating voltage range AVSS to AVDD to drive the blue subpixels in the second line period.

That is to say, the first driver unit 211 is not always supplied with the first operating voltage range AVSS to AVDD, and the second driver unit 212 is not always supplied with the second operating voltage range AVSS to VCI. The operating voltage ranges of the first driver unit 211 and the second driver unit 212 are switched by the display line, which also means the operating voltage ranges of the first driver unit 211 and the second driver unit 212 are switched according to the colors of the subpixels to be driven. The third driver unit 213 is always supplied with the second operating voltage range AVSS to VCI in the odd line periods and the even line periods.

In comparison, in the embodiment of FIG. 3, in any current line period the first driver unit 111 is always supplied with the first operating voltage range AVSS to AVDD, and the second driver unit 112 and the third driver unit 113 are always supplied with the second operating voltage range AVSS to VCI in the odd line periods and the even line periods.

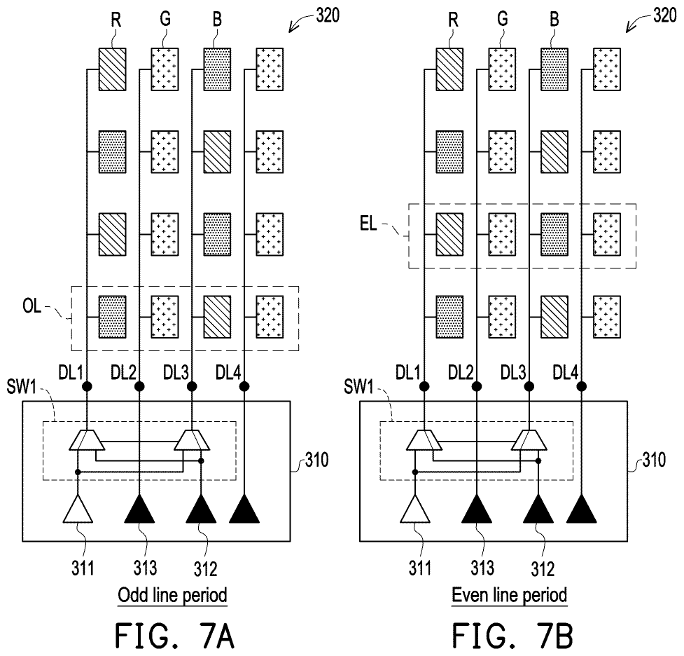

FIG. 7A and FIG. 7B are schematic diagrams respectively illustrating a display device operating in the odd line period and the even line period according to another embodiment of the invention. Referring to FIG. 7A and FIG. 7B, the driver circuit 310 further includes a first switch unit SW1 for switching the connection of data lines DL1 and DL3 and driver units 311 and 312. The data lines DL1 to DL4 of the display panel 320 are also arranged in the stripe wiring pattern. The data lines DL1 and DL3 are connected to the subpixels of two different colors (red and blue). The data lines DL1 and DL3 are connected to the different driver units 311 and 312 in different line periods by switching the first switch unit SW1, so that the data voltage VD of each SOP only drives the subpixel of the same color.

In the odd line period, as shown in FIG. 7A, the first switch unit SW1 is switched to connect the first driver unit 311 to the first data line DL1 and connect the second driver unit 312 to the second data line DL3. Therefore, the first driver unit 311 and the second driver unit 312 can respectively drive the blue subpixel B and the red subpixel R of the odd line OL in the odd line period.

In the even line period, as shown in FIG. 7B, the first switch unit SW1 is switched to connect the first driver unit 311 to the second data line DL3 and connect the second driver unit 312 to the first data line DL1. Therefore, the first driver unit 311 and the second driver unit 312 can respectively drive the blue subpixel B and the red subpixel R of the even line EL in the even line period.

To be specific, in the present embodiment, the first driver unit 311 is always supplied with the first operating voltage range AVSS to AVDD, and the second driver unit 312 and the third driver unit 313 are always supplied with the second operating voltage range AVSS to VCI in the odd line periods and the even line periods. In different line periods, the connection of data lines DL1 and DL3 and driver units 311 and 312 are switched.

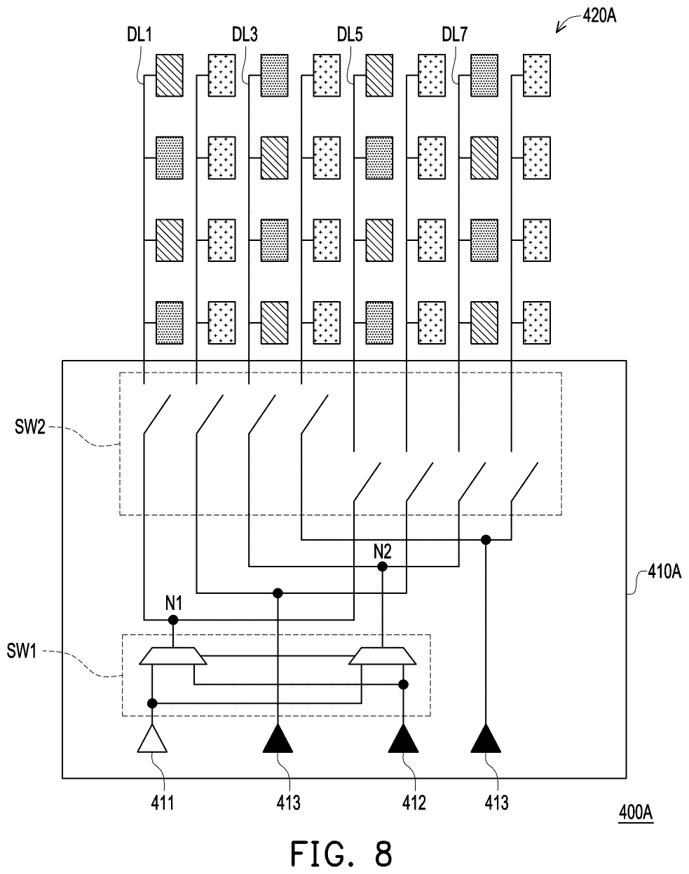

FIG. 8 is a schematic diagram illustrating a display device according to another embodiment of the invention. Referring to FIG. 8, the data lines of the display panel 420 are also arranged in the stripe wiring pattern, and the driver circuit 410A further includes a second switch unit SW2 coupled to the first switch circuit SW1.

The data lines DL1, DL3, DL5 and DL7 are connected to the subpixels of two different colors (red and blue). The data lines DL1, DL3, DL5 and DL7 are connected to the different driver units 411 and 412 in different line periods by switching the switch units SW1 and SW2, so that the data voltage VD of each SOP only drives the subpixel of the same color.

The second switch circuit SW2 is configured to time-divisionally connect one output of a plurality of outputs of the first switch unit to different data lines. For example, the first switch unit 411 has two outputs N1 and N2, and the second switch circuit SW2 time-divisionally connects one output N1 of the first switch unit SW1 to the different data lines DL1 and DL5 in the odd line period. Next, in the same odd line period, the second switch circuit SW2 further time-divisionally connects the other output N2 of the first switch unit SW1 to the different data lines DL3 and DL7.

In the present embodiment, the first driver unit 411 is always supplied with the first operating voltage range AVSS to AVDD, and the second driver unit 412 and the third driver unit 413 are always supplied with the second operating voltage range AVSS to VCI in the odd line periods and the even line periods.

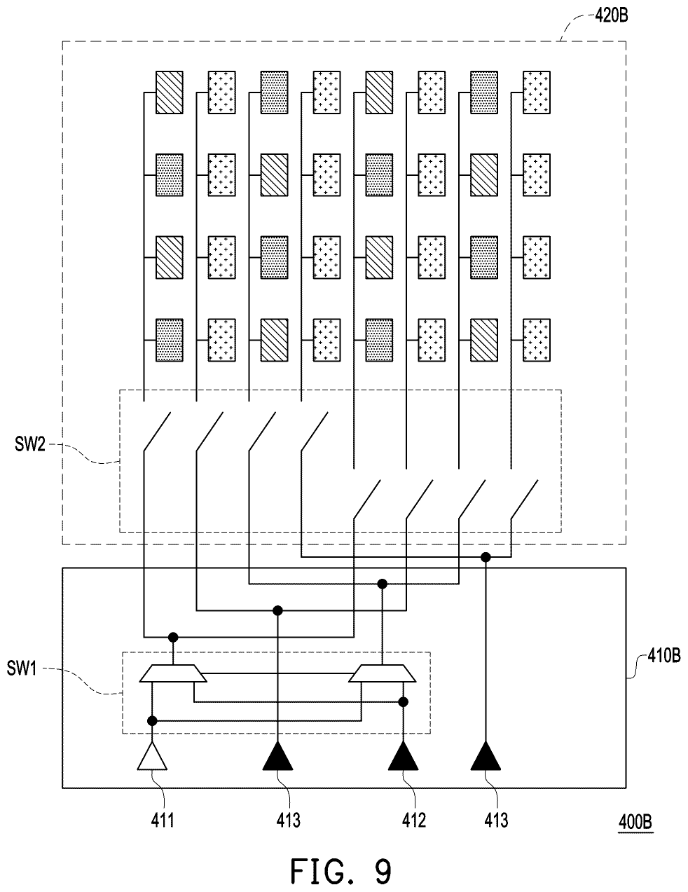

FIG. 9 is a schematic diagram illustrating a display device according to another embodiment of the invention. Referring to FIG. 8 and FIG. 9, the display device 400B of FIG. 9 is similar to the display device 400A of FIG. 8, and the main difference therebetween, for example, lines in that the second switch unit SW2 is disposed in the display panel 420B. The driving method of this embodiment is sufficiently taught, suggested, and embodied in the embodiments illustrated in FIG. 8, and therefore no further description is provided herein.

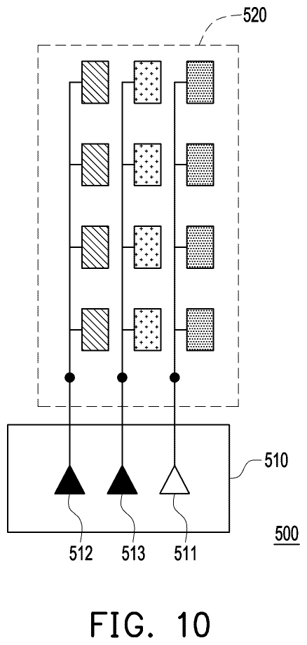

In the embodiments of FIG. 3, FIG. 6A, FIG. 6B, FIG. 7A, FIG. 7B, FIG. 8 and FIG. 9, the display panels are subpixel rendering display panels, but the driving method of the invention can also be applied to true RGB display panels, as shown in FIG. 10. FIG. 10 is a schematic diagram illustrating a display device 500 according to another embodiment of the invention. Referring to FIG. 10, the display panel 520 is a true RGB display panel. The first driver units 511 are supplied with the first operating voltage range AVSS to AVDD, and the second driver units 512 and the third driver units 513 are supplied with the second operating voltage range AVSS to VCI.

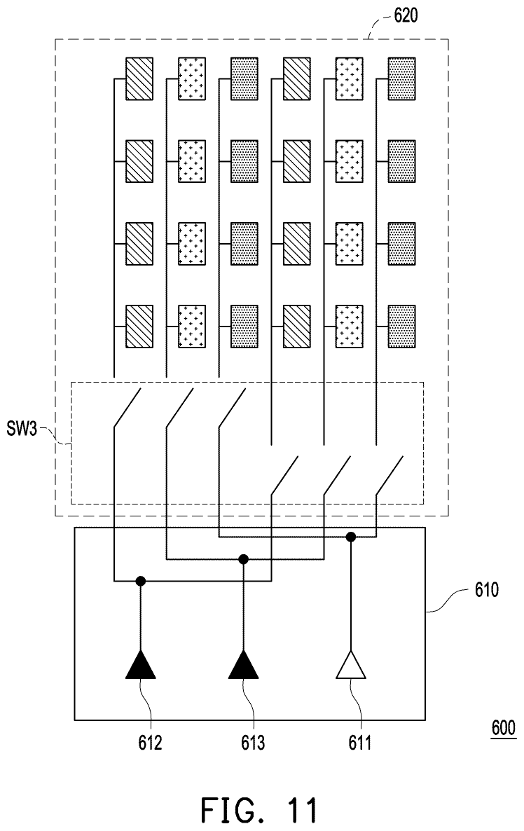

FIG. 11 is a schematic diagram illustrating a display device 600 according to another embodiment of the invention, wherein the display panel 620 is also a true RGB display panel. Referring to FIG. 11, the display panel 620 further includes a switch unit SW3. The SOPs of the driver units 611, 612, 613 may time-divisionally output the data voltage VD to drive the subpixel of the same color coupled by different data lines. The data voltage VD outputted by each SOP only drives the subpixel of the same color.

In summary, in the embodiments of the invention, corresponding to the display panel with different subpixels having different ELVDD voltages, the driver units are supplied with different operating voltages in order to avoid a waste of power consumption caused by all the SOPs sharing the same operating voltage. Accordingly, a power saving effect is achieved by the driver circuit.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A driver circuit, configured to drive a display panel, wherein the display panel comprises a plurality of data lines and a plurality of subpixels, the driver circuit comprising:
a plurality of first driver units, supplied with a first operating voltage range and configured to drive blue subpixels; and
a plurality of second driver units, supplied with a second operating voltage range and configured to drive red subpixels, wherein the first operating voltage range is larger than the second operating voltage range.

2. The driver circuit of claim 1, wherein the first driver units are always supplied with the first operating voltage range and the second driver units are always supplied with the second operating voltage range in odd line periods and even line periods.

3. The driver circuit of claim 1, further comprising:
a first switch unit, configured to connect one first driver unit of the first driver units to a first data line in a first line period and connect the first driver unit to a second data line in a second line period next to the first line period, and also connect one second driver unit of the second driver units to the second data line in the first line period and connect the second driver unit to the first data line in the second line period.

4. The driver circuit of claim 3, further comprising:
a second switch circuit, coupled to the first switch circuit, and configured to time-divisionally connect one output of a plurality of outputs of the first switch unit to different data lines.

5. The driver circuit of claim 1, further comprising:
a plurality of third driver units, supplied with one of the first operating voltage range and the second operating voltage range and configured to drive green subpixels.

6. The driver circuit of claim 5, wherein the third driver units are always supplied with a determined operating voltage range which is either the first operating voltage range or the second operating voltage range in odd line periods and even line periods.

7. The driver circuit of claim 1, wherein
wherein the first driver units are supplied with the first operating voltage range to drive the blue subpixels in a first line period and are supplied with the second operating voltage range in place of the first operating voltage range to drive the red subpixels in a second line period next to the first line period; and
wherein the second driver units are supplied with the second operating voltage range to drive the red subpixels in the first line period and are supplied with the first operating voltage range in place of the second operating voltage range to drive the blue subpixels in the second line period.

8. The driver circuit of claim 1, wherein the minimum voltage of the first operating voltage range is the same as that of the second operating voltage range, and the maximum voltage of the first operating voltage range is larger than that of the second operating voltage range.

9. The driver circuit of claim 1, wherein the minimum voltage of the first operating voltage range is lower than that of the second operating voltage range, and the maximum voltage of the first operating voltage range is the same as that of the second operating voltage range.

10. A display panel, comprising:
a plurality of pixel units, each comprising at least two of a blue subpixel, a red subpixel, and a green subpixel, wherein
the blue subpixel is coupled between a first voltage and a second voltage, wherein the first voltage is larger than the second voltage;
the red subpixel is coupled between a third voltage and the second voltage, wherein the third voltage is larger than the second voltage; and
the green subpixel is coupled between a fourth voltage and the second voltage, wherein the fourth voltage is larger than the second voltage, wherein at least two voltages of the first voltage, the third voltage, and the fourth voltage have different voltage values.

11. The display panel of claim 10, wherein the first voltage, the third voltage, and the fourth voltage have different voltage values.

12. The display panel of claim 10, wherein the blue subpixel, the red subpixel, and the green subpixel have separate anodes coupled to the first voltage, the third voltage, and the fourth voltage, respectively.

13. The display panel of claim 10, further comprising a plurality of data lines, coupled to respective subpixels of the blue subpixel, the red subpixel, and the green subpixel, wherein each of the data lines is coupled to the subpixels having the same color.

14. The display panel of claim 10, further comprising a plurality of data lines, coupled to respective subpixels of the blue subpixel, the red subpixel, and the green subpixel, wherein a part of the data lines is coupled to the subpixels having different colors.

15. The display panel of claim 10, wherein the display panel is coupled to a driver circuit, the driver circuit comprises a plurality of driver units, and the display panel further comprises:
a switch circuit, coupled to the driver units, and configured to time-divisionally connect outputs of the driver units to different data lines.

16. The display panel of claim 15, wherein the driver units drive different groups of the data lines in a time-division manner.

17. A display device, comprising:
a display panel, comprising a plurality of data lines and a plurality of pixel units, wherein each of the pixel units comprises at least two of a blue subpixel, a red subpixel, and a green subpixel; and
a driver circuit, configured to drive the display panel, and comprising:
a plurality of first driver units, supplied with a first operating voltage range and configured to drive the blue subpixels; and
a plurality of second driver units, supplied with a second operating voltage range and configured to drive the red subpixels, wherein the first operating voltage range is larger than the second operating voltage range.

18. The display device of claim 17, wherein the first driver units are always supplied with the first operating voltage range and the second driver units are always supplied with the second operating voltage range in odd line periods and even line periods.

19. The display device of claim 17, further comprising:
a first switch unit, configured to connect one first driver unit of the first driver units to a first data line in a first line period and connect the first driver unit to a second data line in a second line period next to the first line period, and also connect one second driver unit of the second driver units to the second data line in the first line period and connect the second driver unit to the first data line in the second line period.

20. The display device of claim 19, further comprising:
a second switch circuit, coupled to the first switch circuit, and configured to time-divisionally connect one output of a plurality of outputs of the first switch unit to different data lines.

21. The display device of claim 17, further comprising:
a plurality of third driver units, supplied with one of the first operating voltage range and the second operating voltage range and configured to drive the green subpixels.

22. The display device of claim 21, wherein the third driver units are always supplied with a determined operating voltage range which is either the first operating voltage range or the second operating voltage range in odd line periods and even line periods.

23. The display device of claim 17, wherein
wherein the first driver units are supplied with the first operating voltage range to drive the blue subpixels in a first line period and are supplied with the second operating voltage range in place of the first operating voltage range to drive the red subpixels in a second line period next to the first line period; and
wherein the second driver units are supplied with the second operating voltage range to drive the red subpixels in the first line period and are supplied with the first operating voltage range in place of the second operating voltage range to drive the blue subpixels in the second line period.

24. The display device of claim 17, wherein the minimum voltage of the first operating voltage range is the same as that of the second operating voltage range, and the maximum voltage of the first operating voltage range is larger than that of the second operating voltage range.

25. The display device of claim 17, wherein the minimum voltage of the first operating voltage range is lower than that of the second operating voltage range, and the maximum voltage of the first operating voltage range is the same as that of the second operating voltage range.

26. The display device of claim 17, wherein the blue subpixel is coupled between a first voltage and a second voltage, wherein the first voltage is larger than the second voltage; the red subpixel is coupled between a third voltage and the second voltage, wherein the third voltage is larger than the second voltage; and the green subpixel is coupled between a fourth voltage and the second voltage, wherein the fourth voltage is larger than the second voltage, wherein at least two voltages of the first voltage, the third voltage, and the fourth voltage have different voltage values.

27. The display device of claim 26, wherein the first voltage, the third voltage, and the fourth voltage have different voltage values.

28. The display device of claim 26, wherein the blue subpixel, the red subpixel, and the green subpixel have separate anodes coupled to the first voltage, the third voltage, and the fourth voltage, respectively.

29. The display device of claim 26, wherein each of the data lines is coupled to the subpixels having the same color.

30. The display device of claim 26, wherein a part of the data lines is coupled to the subpixels having different colors.

31. The display device of claim 26, wherein the display panel further comprises a switch circuit, the switch circuit is coupled to the first driver units and the second driver units, and configured to time-divisionally connect outputs of the first driver units and the second driver units to different data lines.

32. The display device of claim 31, wherein the first driver units and the second driver units drive different groups of the data lines in a time-division manner.
